(19) United States
(12) Patent Application Publication
(10) Pub. No.: US 2011/0022231 A1
(43) Pub. Date: Jan. 27, 2011

(54) Apparatuses, Systems and Methods for Automated Crop Picking

(76) Inventors: Jeffrey WALKER, Clovis, CA (US); Lev DRUBETSKY, Vancouver (CA)

Correspondence Address: THE LAW OFFICES OF ANDREW D. FORTNEY, PH.D., P.C., 215 W FALLBROOK AVE SUITE 203, FRESNO, CA, 93711, US

(21) Appl. No.: 12/843,790

(22) Filed: Jul. 26, 2010

Related U.S. Application Data
(60) Provisional application No. 61/228,569, filed on Jul. 25, 2009.

(51) Int. Cl. G06F 19/00; G05B 19/042; B23P 11/00

(52) U.S. Cl. 700/259; 700/245; 29/428; 901/2; 901/14; 901/47

(57) ABSTRACT

Automated apparatuses and related methods for scanning, spraying, pruning, and harvesting crops from plant canopies. The apparatuses include a support structure comprising a frame, a central vertical shaft, and at least one module support member capable of rotating around a plant canopy. The support member supports a plurality of movable arms, each arm having at least one detector for probing the plant canopy. Embodiments further comprise applicators and/or manipulators for spraying, pruning, and harvesting crops from within the plant canopy. The methods of the present invention include causing the moveable arms attached to the support structure to be extended into the plant canopy, searching for crops, and transmitting and/or storing the search data. Embodiments further comprise detaching crops from the plant canopy and transporting them to a receptacle, applying a controlled amount of material within the plant canopy, or pruning inside of the plant canopy.

### RELATED APPLICATIONS

This application claims the benefit of U.S. Provisional Application No. 61/228,569, filed Jul. 25, 2009, incorporated herein by reference in its entirety.

### FIELD OF THE INVENTION

The present invention generally relates to the field of automated crop harvesting. More specifically, but without limitation, embodiments of the present invention include machines, apparatuses, systems and methods for automated or robotic scanning, spraying, pruning, trimming, and harvesting of agricultural crops from within a tree or plant canopy.

### BACKGROUND

Because of the high cost of manual labor for harvesting fruit crops, there have been a large number of attempts to build robotic harvesters for fruit crops over the years, all of them unsuccessful in achieving commercialization. There have been a variety of approaches utilized, most of the early attempts being mechanical systems designed to dislodge fruit from the tree in situ. Early descriptions include the “shake-catch” system in which a device is applied to the trunk of the tree to induce significant oscillation or vibratory forces to dislodge the fruit from the tree, such as those disclosed in U.S. Pat. Nos. 4,606,179 and 5,816,037. There have also been a number of attempts to utilize more specific branch-shaking techniques to shed fruit from the tree branches using large spike-drum arrays which induce oscillation of the spike arrays when they enter the canopy of the tree, such as those disclosed in U.S. Pat. Nos. 4,860,529 and 5,946,896. More recently, a system was described in which a harvester incorporated an “impactor” designed to dislodge the fruit from a tree and a catchment system that attempts to minimize damage to the falling fruit, found in U.S. Pat. No. 6,442,920 B1. In general, mechanical systems have not been overwhelmingly commercially successful, and the primary reasons appear to revolve around resulting damage to the fruit, damage to the trees and insufficient yield for commercial operations.

Recent efforts have focused on a targeted approach to the removal of fruit from trees, using vision systems to detect and locate each piece of fruit, with subsequent removal by mechanical actuators in a more traditional robotic concept. These machine-vision systems first map the field to determine locations, numbers and size of targeted fruit using a scouting system, and determine optimal picking solutions for each piece of fruit. This information is then transferred to separate robotic end-effector units that are responsible for actually picking the fruit. One recent patent application described a robotic scout system that moves through the orchard to map the fruit, plans an effective picking strategy, and then relies on a separate harvesting unit that moves through the orchard to harvest the fruit. U.S. Pat. App. Publ. No. 2005/0126144A1.

The system of U.S. Pat. App. Publ. No. 2005/0126144A1 suffers from several drawbacks. First, the use of two modules (a scout and a picker) results in duplicative hardware, and the potential need for two different operators. Using two modules also results in a delay between mapping and actual harvesting. This means that there is no real-time guiding, giving rise to several possible error sources for positioning of the removal mechanism relative to fruit as previously mapped, such as wind or other environmental changes, error in positioning the picker's coordinate system relative to the mapping machine's coordinate system, etc. In addition, such a two-module system requires a large number of cameras or sensors in the scout to probe around and into each tree, as well as a similar set of cameras or sensors in the picker to find, move to, and remove the mapped fruit. Since a given orange tree may contain between 800-1200 pieces of fruit, mapping each piece of fruit for an orchard of hundreds of trees involves massive data collection, computation and storage. Then, complicated mechanical apparatus are required on both the mapping and harvesting modules. Implementing individual picking solutions for each piece of fruit leads to slow fruit picking/collection of up to perhaps one hour per tree. For complex 5-6 degrees of freedom manipulators, more complicated algorithms are needed and more time will be required to reach obscured fruits. Arms having more joints and movement capability are more prone to failure in field conditions. Then, if the arms are not just removing fruits but carrying them to accumulating containers, the harvest time may be unsatisfactorily long, and the fruit may be damaged as well. In sum, the system described in U.S. Pat. App. Publ. No. 2005/0126144A1 appears to be relatively complex, expensive, prone to error, and inefficient.

It is therefore desirable to provide reliable, efficient and economical machines, systems and methods of harvesting fruit crops that do not damage the fruit and that can quickly harvest a high percentage of usable fruit from trees in a relatively short period of time. Likewise, it is also desirable to provide reliable efficient and economical machines, systems and methods for scanning, spraying and pruning of agricultural crops.

### SUMMARY

Unlike previous attempts that rely either on sophisticated machine-vision systems that map specific locations of individual pieces of fruit, or “blind” mechanical harvesters that rely on bulk harvesting techniques using physical disruption of the fruit/stem/branch interface, embodiments of the present invention provide machines, systems and methods that do not require pre-mapping or pre-knowledge of the position/location of the crops on the plants, do not require pre-calculation of a picking plan, and yet are highly effective at locating and picking individual pieces of fruit or other types of crops. These machines and methods employ one or more highly packed modules or arrays of movable arms, with crop removal or other devices, so as to employ some of the beneficial aspects of mass harvesting techniques. The modules or arrays can have a variable number of moveable arms depending on the particular crop to be harvested and the size and the shape of the trees or plants.

Each picking module or array can deploy multiple individual and independently controlled moveable arms, arranged in parallel rows or other grid configurations, which move into the tree canopy using telescopic or other extension/retraction mechanisms to reach individual fruits within a predetermined region of the tree canopy. For example, each arm is capable of moving within a pre-designated three-dimensional search grid or box, and is capable of rapidly probing or scanning that grid or box as its target area to determine whether fruit is present. This may be accomplished with one or more sensors, including, without limitation, video cameras with shape analyzing algorithms and/or spectral analyses, scanners (such as laser scanners), sensors (such as thermal imaging sensors, and/or ultrasound imaging sensors), etc.

Once a suitable target (fruit) is detected, the arm can be guided by the sensor(s) and a search algorithm to assure terminal guidance of the arm adjacent to the target fruit. Once the arm is moved into position adjacent to the fruit, the search algorithm can guide attachment of a gripping device to hold the fruit. Depending on the type of fruit being harvested, the gripping device may include one or more suction cups, pneumatic grippers, movable clamps, movable fingers, movable tines, and/or combinations thereof. Once the gripper engages the fruit, it can then be removed using high speed rotation and push/pullor other removal techniques, leaving the button/star of the fruit intact. It is to be appreciated that any combination of sensors and gripping mechanisms may be used, depending on the type of crop to be harvested, the anticipated environment within the tree canopy, weather conditions, and other relevant factors. It is also to be appreciated that if a sensor on a particular arm detects the presence of a piece of fruit that is nearby but outside of the grid or box for that particular arm (i.e., that cannot be picked by that particular arm), the location information may be provided to an adjacent arm that may be capable of picking the fruit.

When all possible locations have been searched and picked within a zone for a given module or array of arms, embodiments of the invention will retract the arms, automatically move the module support member or frame holding the arms a short distance or arc around the vertical axis defined by the trunk of the tree or center of the canopy or the apparatus (typically in the range of from 5-45 degrees, e.g. from 5-30 degrees, or any other range of values therein, depending on the diameter of the tree canopy), and initiate the search/harvest process again at the new location. The process is repeated in a pattern designed to cover all possible locations of fruits within the canopy (e.g. the space occupied by the tree or plant). This offers the advantage of multiple searches for fruit that might have been initially blocked by a branch or other obstacle. Depending on the diameter of the tree, the number of arrays of picking arms, the number of arms in each array, the sensitivity of the sensor, the software, the mechanism for extending and retracting the arms, etc., the machines, systems and methods of the present invention are capable of efficiently harvesting a high percentage of crops from a given tree in less than 10 minutes, and possibly in a range of 5-6 minutes per tree. In some embodiments, this short amount of time is all that is needed to complete a series of rotations designed to cover 360 degrees of the circumference of the tree.

Some embodiments of the invention include a four-pillar gantry system that is designed to straddle each individual tree or plant in order to deploy picking modules or arrays on multiple sides of the tree. In these embodiments, each base, pillar or leg of the gantry system may be self-propelled and/or individually controlled, allowing a high degree of movement and agility as the gantry moves through the orchard. In these embodiments, each leg may be independently vertically adjusted to properly level the gantry system during use. In some embodiments, each gantry is controlled directly by an operator who sits at a small console mounted to one leg of the gantry. In other embodiments, the machine is remotely guided using GPS, video camera technology or a combination of both, to permit remote control from an operator using a central console to control more than one unit.

Other embodiments include a motor vehicle mounted machine that moves between rows of plants. The machine cantilevers over the plant canopy and rapidly probes the plant canopy to scan, spray, prune and/or pick fruit within the plant canopy.

In some embodiments of the invention, a pre-defined 3-D Cartesian coordinate search pattern, that may be consistent or may be varied from tree to tree, is assigned to each individual picking arm, and fine-motor control is achieved using vision or other sensory systems (such as a scanner). In some embodiments, the invention includes collector baskets/netting at the base of the device to capture and transport picked fruit into loading bins that may be on-board the harvesting apparatus and/or pre-positioned throughout the orchard. As a bin fills, it can be placed on the ground for later collection, and a replacement bin substituted therefore.

It is to be appreciated that important embodiments of the present invention include semi-autonomous crop harvesters, wherein a mass collection approach is combined with artificial intelligence for harvesting fresh fruit citrus products including, but not limited to navel oranges, valencia oranges and lemons. However, the scope of the invention encompasses, without limitation, machines, systems, apparatus and methods for use with other types and varieties of crops, and for other purposes including, but not limited to scanning, spraying, pruning, and trimming of agricultural crops.

The approach of the present invention is unique for many reasons including (1) coverage of practically every possible location of a piece of fruit on a tree or plant is accomplished efficiently and effectively without pre-mapping or pre-knowledge of the location; (2) employment of high density picking arms rapidly probe a tree or plant to quickly determine possible targets; (3) employment of a terminal sensory/vision guidance system with fine motor control, which accurately attaches the gripper or other device mounted on each of the moveable arms to an individual piece of fruit, thus preventing damage to the fruit; (4) use of a simplified algorithm for three-axis movement of the moveable arms, minimizing the possibility for interference between arms and maximizing the insertion and retraction speed; (5) elimination of a multi-vehicle system requiring two or more autonomously controlled vehicles and the inherent complexity of data transfer in such a system (e.g. in less than ideal environmental conditions such as rain and wind); (6) nearly simultaneous scanning and picking, permitting real-time adjustment for environmental conditions as well as adjustment for the reduced weight of branches following the removal of fruit (the subsequent upward vertical movement of the branch when attempting to access the remaining fruit); and (7) use of a unique combination of high speed rotation and -push/pull that quickly removes each individual piece of fruit from the tree without damage. These and other advantages of the present invention will become readily apparent from the detailed description below.

### BRIEF DESCRIPTION OF THE DRAWINGS

FIG. 1A is a perspective view of a first exemplary embodiment of an apparatus for automated crop picking using a gantry, wherein the gantry may be rotated 360 degrees around the plant canopy.

FIG. 1B is a perspective view of a second exemplary embodiment of an apparatus for automated crop picking using a gantry, wherein the module support members are rotated around the plant canopy.

FIG. 1C is a side view of the gantry embodiment of FIG. 1B.

FIG. 1D is an elevation view of an exemplary embodiment of an apparatus for automated crop picking using a truck-mounted unit.

FIG. 2A is a perspective view of an exemplary embodiment of a telescopic moveable arm utilizing a crop removal manipulator.

FIG. 2B is a perspective view of a telescoping moveable arm, showing three degrees of freedom of movement in the X, Y and Z directions, according to an embodiment.

FIG. 3 is a section view of an exemplary embodiment of an end-effector with suction cup crop removal device.

FIG. 4A is a diagram of the sequence of operation of a suction cup crop removal device, showing capture, rotary movements, and fruit drop down, according to an embodiment.

FIG. 4B is a diagram of the sequence of operation of a suction cup crop removal device wherein the crop is pulled down into the end-effector of the moveable arm prior to retraction of the arm from the plant canopy.

FIG. 5 is a top view of a plant canopy showing an exemplary embodiment of overlapping search spaces of a moveable arm.

FIG. 6 is a perspective view of a plant canopy showing an exemplary embodiment of the three-dimensional search space of a single moveable arm with a manipulator.

FIG. 7 is a diagram of the search space or process box of a moveable arm, according to an embodiment.

FIG. 8A is a section view of an exemplary embodiment of a crop removal device showing attachment of a piece of fruit when the vertical axis of the fruit is aligned with the vertical axis of the suction cup.

FIG. 8B is a schematic of a crop removed by rotation only when the vertical axis of the fruit is aligned with the vertical axis of the suction cup.

FIG. 8C is a section view of an exemplary embodiment of a crop removal device showing attachment of a piece of fruit when the vertical axis of the fruit does not coincide with the suction cup's axis of rotation.

FIG. 8D is a schematic of a crop removed by both rotational and linear motion when the vertical axis of the fruit does not coincide with the suction cup's axis of rotation.

FIG. 9 is a section view of an exemplary embodiment of a telescopic arm.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention as defined by the appended claims. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures, components and materials have not been described in detail so as not to unnecessarily obscure aspects of the present invention.

For the sake of convenience, the terms “module” and “array” are generally used interchangeably herein, as are the terms “tree” and “plant,” and the terms “fruit” and “crop,” but these terms are generally given their art-recognized meanings. Also, for convenience and simplicity, the terms “gripper” and “suction cup” are also used interchangeably, as are the terms “manipulator” and “end-effector,” as well as the terms “connected to,” “coupled with,” “coupled to,” and “in communication with” (which terms also refer to direct and/or indirect relationships between the connected, coupled and/or communicating elements unless the context of the term's use unambiguously indicates otherwise), but these terms are also generally given their art-recognized meanings.

The inventions, in its various aspects, will be explained in greater detail below with regard to exemplary embodiments.

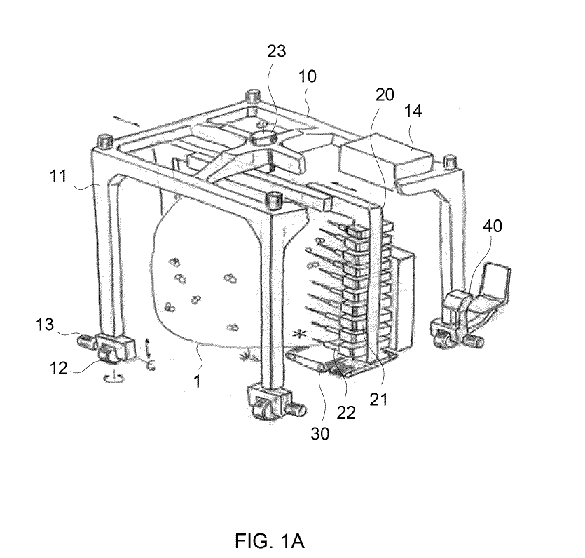

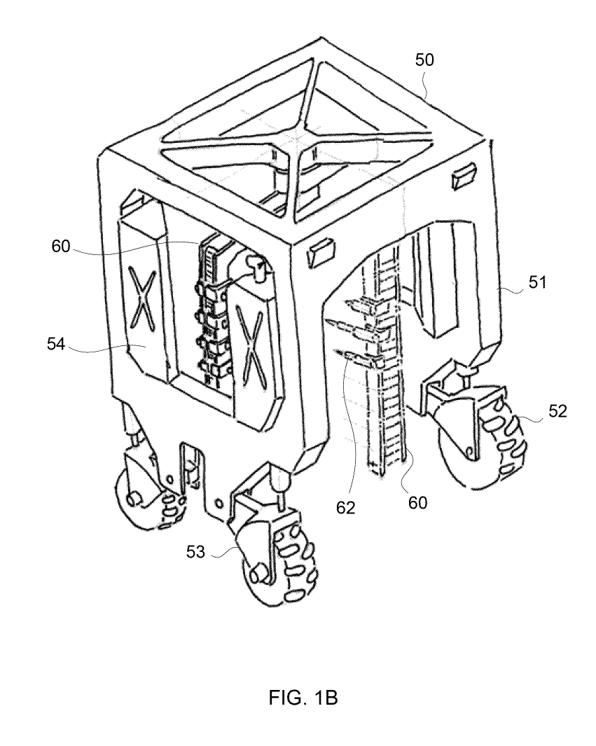

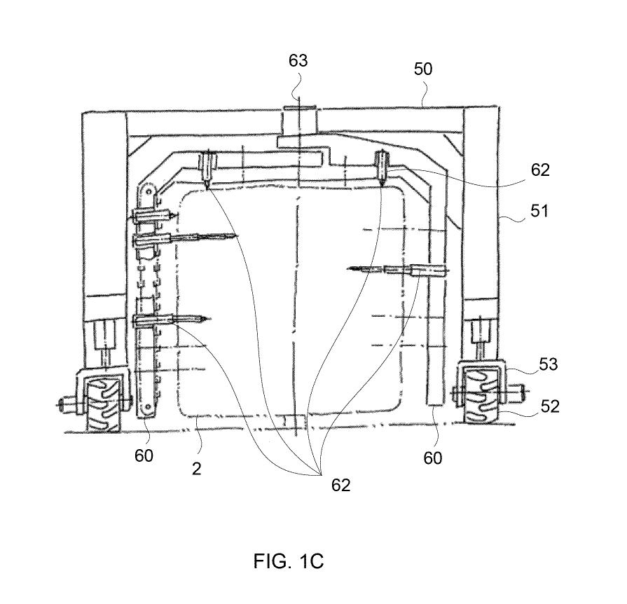

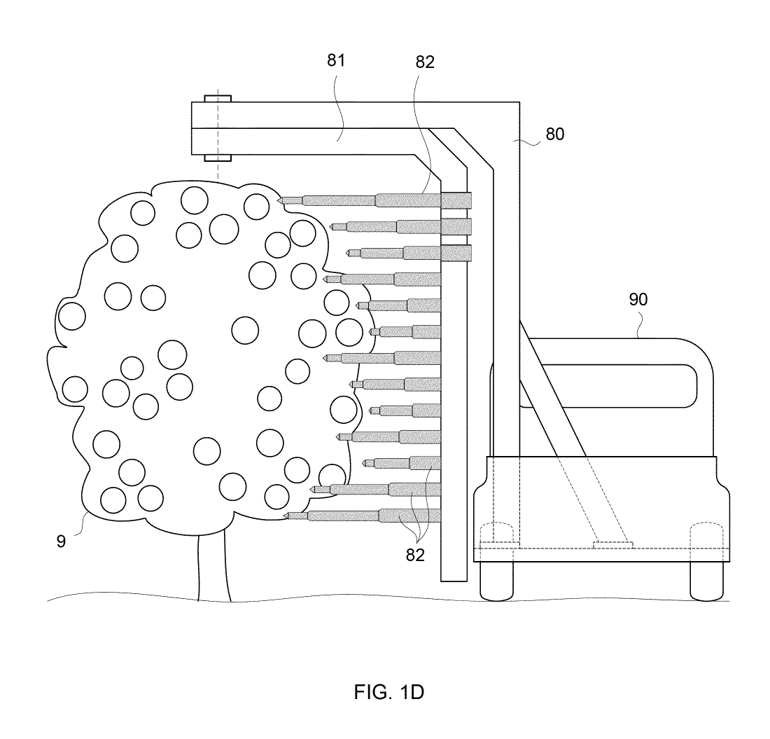

Referring to the drawings wherein like reference characters designate like or corresponding parts throughout the several views, and referring particularly to the exemplary embodiments of FIGS. 1A-1C, it is seen that these embodiments disclose a gantry or portal-type support structure 10, 50 capable of self-alignment relative to the processed tree 1. The gantry is designed to drive over each tree so that it will straddle the tree as shown in FIG. 1A. In these exemplary embodiments, each of the vertical supports 11, 51 has independent height control and is mounted on a wheel 12, 52 with an independent drive system 13, 53. The embodiments of FIGS. 1A-1C are therefore capable of automatically leveling the machine on uneven ground, and capable of movement in any direction by turning the wheels in differing directions.

The main power components 14, 54 are located on the top platform of the gantry or portal-type support structure 10, 50, or are mounted to the sides of the support structure 10, 50, and these components may comprise, without limitation, an engine, a generator, or one or more hydraulic and/or pneumatic pumps, jacks or cylinders. The main power components may operate on a variety of potential power or fuel sources such as propane, solar, gasoline, and/or a battery. One or more processors/CPU units (not shown) and a communication system (also not shown) that is capable of responding to remote direction and/or GPS input are located on the top platform of the gantry or portal-type support structure 10, 50 or mounted to the sides of the support structure 10, 50.

These embodiments can also include the use of mounted video cameras (not shown) on the support structure 10, 50 or on the vertical gantry legs 11, 51, which permit visualization of the legs 11, 51 and the support structure 10, 50 during repositioning and scanning, spraying, pruning and/or picking. These cameras may transmit information to a remote control station (not shown) where one or more units may be under the control of a single operator. However, in these embodiments, the probing, scanning, spraying, pruning, or picking of fruit is done automatically. The advantages of these semi-autonomous embodiments is that a single operator can oversee positional guidance of the gantry, simplified operational software can be employed, any need for autonomous guided technologies such as GPS can be eliminated, time to market can be reduced, design can be simplified, and the equipment may be produced at a lower cost. In another embodiment, the cameras are communicatively connected to an onboard monitoring station 40 as shown in FIG. 1A. Some embodiments may also incorporate advanced navigational aids such as GPS to provide additional automation and autonomous movement.

In the exemplary embodiment of FIG. 1A, the support structure 10 is capable of rotating 360 degrees around a vertical axis 23 so as to position a plurality of modules or arrays 21 of moveable arms 22 around the circumference of the plant canopy 1. The modules or arrays 21 are attached to a module support member 20 comprising a horizontally-extending portion and two vertical members attached to the horizontally-extending portion. The moveable arms 22 can be deployed in a pre-programmed search pattern to locate fruit within a particular three-dimensional space. After the moveable arms 22 complete their searching, scanning, spraying, pruning or picking of fruit from the three-dimensional space, the module support member 20 or the support structure 10 can then be repositioned, and the moveable arms 22 can again be deployed to search, scan, spray, prune or pick another space within the plant canopy 1.

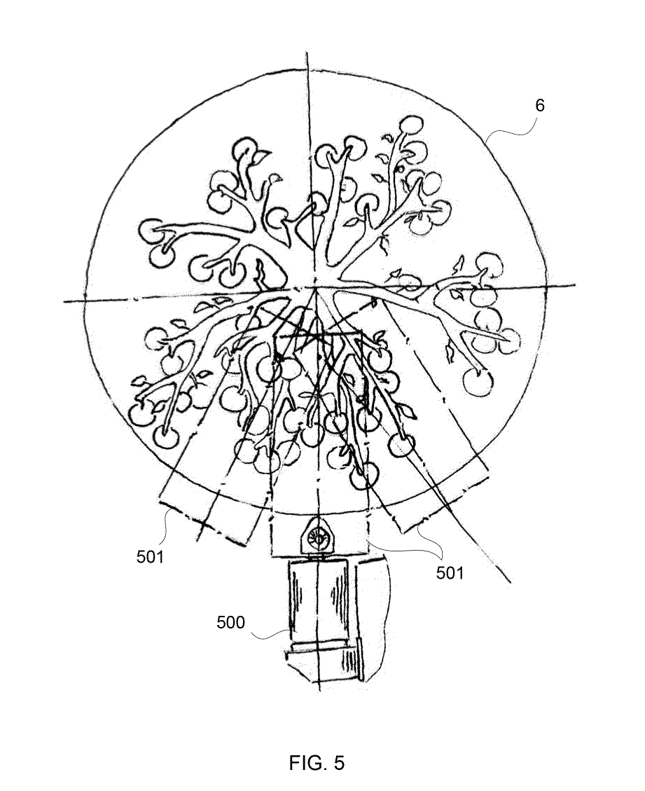

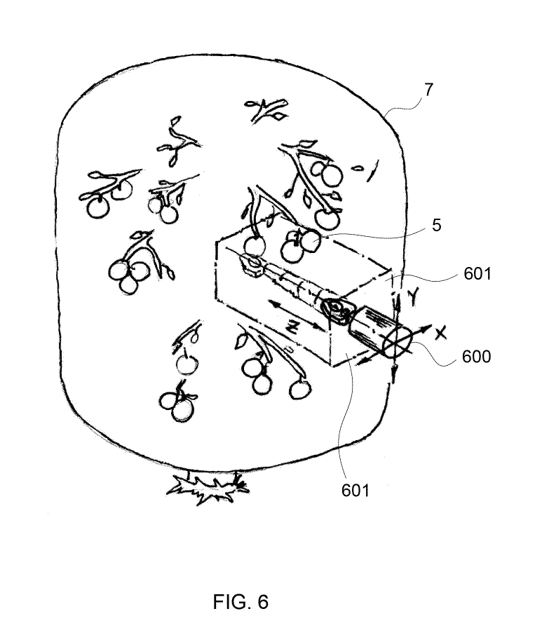

The embodiment of FIGS. 1A-1C divide the plant canopy 1 into discrete searchable and overlapping volumes or spaces as shown in FIGS. 5 and 6, each one covered one or more times by an individual moveable arm 22, 62. The repositioning of the module support member 20, 60 and the overlapping search volumes ensures that most locations for a piece of fruit will be covered by one or more passes of the moveable arms 22, 62.

In the embodiment of FIGS. 1B and 1C, the support structure 50, once positioned over a plant canopy 2, remains stationary, and the module support members 60 holding the moveable arms 62 are rotated, typically from 5 to 30 degrees, depending on (i) the diameter of the plant or tree, and (ii) the number of arrays/module support members 60. In the embodiment of FIGS. 1B and 1C, the moveable arms 62 are attached directly to the module support member 60.

In the embodiment illustrated in FIG. 1A, a module support member 20 is provided in the form of a frame for holding modules or arrays 21 comprising a plurality of moveable arms 22. Ten such modules 21 are disclosed in the exemplary embodiment of FIG. 1A, it being appreciated that any number may be used (generally of at least two), depending on the agricultural crop, configuration of plant canopy, density of fruit and other factors. In FIG. 1A, each module 21 includes two moveable arms 22. In other embodiments, modules 21 could include only a single moveable arm or more than two moveable arms arranged in rows or other grid patterns. The modules or arrays 21 can also be positioned in the same plane as shown, or axially along a curve to facilitate approaching the plant canopy 1 from different angles in different picking configurations. In the embodiment of FIG. 1A, modules or arrays 21 are also configured to rotate around a central axis 23, permitting more diagonal approaches to the trees.

Each moveable arm 22 is extendable and retractable, and in some embodiments this is accomplished using a series of telescoping elements. The proximal end of each arm is attached to the module support member 20, or to a module or array 21 attached to the module support member 20, and the distal end of each arm is provided with at least one detector. In the illustrated exemplary embodiment, the distal end of each arm includes a camera and a suction gripper as described more fully below. It is to be appreciated that any combination of one or more sensors and one or more gripping, spraying, or pruning mechanisms may be used, depending on the type of fruit to be harvested, sprayed or pruned, the anticipated environment within the tree canopy, weather conditions, and other relevant factors. The moveable arms 22 simply search a space or grid to scan and spray, prune and/or pick whatever is there. Each arm 22 relies on vision, ultrasound and/or other sensors for terminal guidance, for fine motion control and successful acquisition of fruit. Preferred embodiments of the system are programmed to search at high speed, penetrating the canopy of the tree in a search grid (and in some embodiments withdrawing if a target is not reached within a predicted period of time; e.g. immediately).

As illustrated in FIG. 1A, collected fruit is dropped onto a conveyor 30 at the bottom of the module or array 21 of moveable arms 22. An operator control station 40 is provided adjacent to one of the vertical supports 11. The station 40 is used by the operator to move the machine from tree to tree in the orchard. In other embodiments, this may be done remotely from a control station (not shown) using a video link, and in yet other embodiments, the movement from tree to tree may be done automatically using GPS, mapping and multiple sensors.

FIG. 1D is an elevation view of an exemplary embodiment showing the support structure 80 mounted in a motor vehicle 90. The support structure 80 and at least one module support member 81, is cantilevered over the plant canopy 9, and a plurality of moveable arms 82 can be positioned in the same plane, or positioned radially to facilitate approaching the plant canopy 9 from different angles. Some embodiments may also include more than one apparatus mounted in the motor vehicle 90, which apparatuses can scan and spray, prune and/or pick from rows (or other configurations) of plant canopies on either side or around the motor vehicle 90. Some embodiments may use more than one vehicle for each row or other grouping of plant canopies.

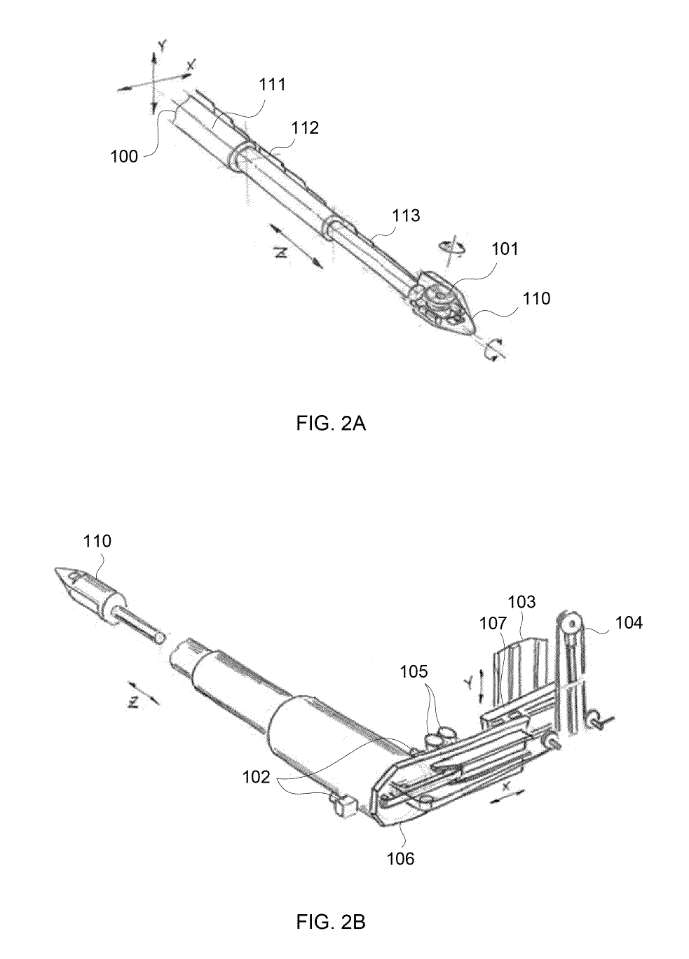

Details of an exemplary telescopic moveable arm 100 with a manipulator or end effector 110 for picking fruit is shown in FIGS. 2A and 2B. In these embodiments, the telescopic moveable arm 100 has three degrees of freedom in the X, Y and Z planes relative to a ground surface, so as to position a suction cup 101 or other crop removal device beneath the fruit (not shown). As shown in FIG. 2A, the telescopic arm 100 has three telescoping sections 111, 112, 113, although as little as two, and more than three sections may be utilized depending on the dimensions, density, and other characteristics of the plant canopy to be penetrated. As shown in FIG. 2B, cameras 102 guide the movement of the telescopic moveable arm 100. X-direction driver 106 and Y-direction driver 104 automatically position the telescopic movable arm 100 relative to the X-direction carriage 107 and the Y-direction carriage 103. Telescopic arm drivers 105 automatically position the telescopic moveable arm 100 in the Z-direction (into the plant canopy).

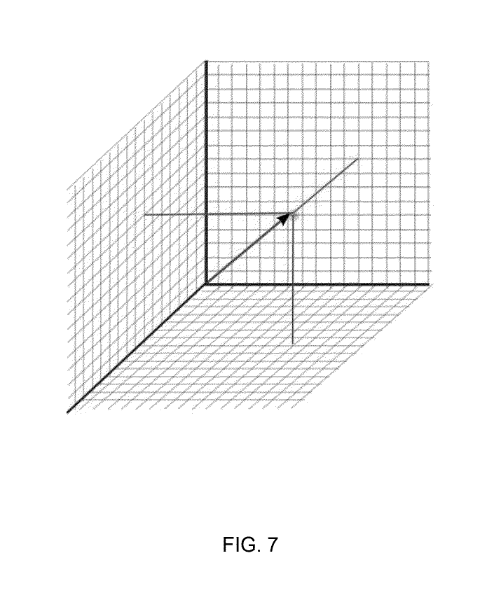

In some embodiments, the range of motion for a given telescopic moveable arm may be 200 mm×200 mm in the X and Y directions, and 1,500 mm in the Z-direction, representing a work zone or grid as depicted in FIG. 7. In some embodiments, the telescopic arm is pre-positioned in the X and Y directions outside of the canopy, and then extended into the plant canopy (the Z direction). In these embodiments, once inside the plant canopy, only small adjustments are made in the X and Y directions to center the manipulator or end-effector on the target. It is to be appreciated that the dimensions of the work zone for a telescoping moveable arm may be modified, expanded or restricted (typically in the range of from 100 to 1000 mm in the X and Y directions, and typically in the range of 300 to 3000 mm in the Z direction, depending upon such factors as the length of the moveable arm, the type of sensor(s), and type of crop removal devices(s) used, the height, radius and diameter of the tree, the type of tree (which may have different branching and tangling challenges), the size of the fruit to be picked, the number of times the array is expected to be moved to harvest the entire tree, and other similar factors. In some embodiments, the movable arm may angularly telescope.

Some embodiments of the invention are programmed to stop advancing should an arm encounter significant resistance, such as that offered by a branch or other obstruction. However, re-entry into the same area from a different angle in a different pass improves the chances of reaching fruit blocked by such an obstruction. In most embodiments, once a target is encountered within a specified range, sensory guidance can be utilized to slow the speed of advancement and to make any adjustments in the X, Y and/or Z directions to position the manipulator 110 or gripper on the fruit. In vision/camera based embodiments, the input utilized for this guidance can be optimized for a wide range of light exposure, uniformity of illumination, color consistency, ability to distinguish background/foreground objects, and/or discriminating fruit from leaf coloration and shape. In such embodiments, each manipulator 110 preferably also includes an illumination system that permits operation under a variety of weather and ambient light conditions. Several methods, such as fluorescence detection, air blowing and others can be used to improve fruit detection based on such factors as the color, shape and density of the fruit. In some embodiments, a combination of static cameras (mounted on the frame or gantry 10, 50, 80) and cameras installed in the manipulators 110 will permit a much more simplified fruit picking algorithm. In embodiments employing air blowers with the manipulators 110, periodic impulses of air may be used to expose fruit that can then be easily distinguished from leaves or other objects as having a much lower natural frequency, density and/or surface-to-volume ratio.

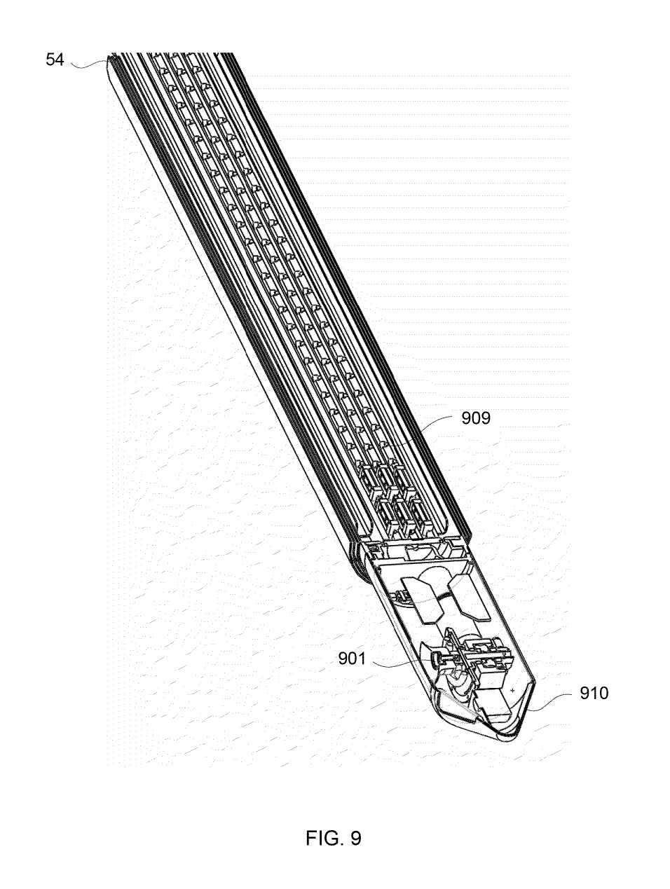

FIG. 9 shows a section view of a telescopic arm 900 with end-effector 910. This embodiment utilizes a chain drive 909 to operate the telescopic arm. Other embodiments of the telescopic arm 900 may comprise, without limitation, a rack and pinion drive system, or one or more hydraulic and/or pneumatic pumps, jacks or cylinders.

Telescopic moveable arms 100, 900 offer a significant advantage compared with multilink automated or robotic arms because they have much easier access to the fruit when penetrating the canopy and branches. This approach also offers a more straightforward path calculation because the three dimensional problem of locating fruit within a plant canopy is essentially reduced to two dimensions, allowing for simplified software algorithms for arm movement. Telescopic arms 100, 900 can also enter and withdraw from the canopy at higher speed compared with more complex multi-link robotic arms. This relatively simplified mechanical design also offers enhancements in product durability and field utility in adverse conditions.

In many embodiments, the manipulators 110, 910 or grippers 101, 901 utilize suction to attach to the fruit. Each manipulator, gripper and/or suction cup may have an individual pneumatic suction or vacuum generating system, or one or more groups of manipulators, grippers and/or suction cups may share a common system with each manipulator, gripper and/or suction cup within the group having an individual value for applying/releasing suction.

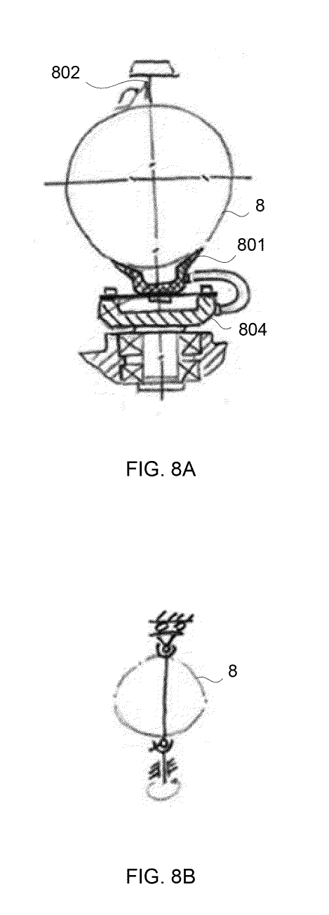

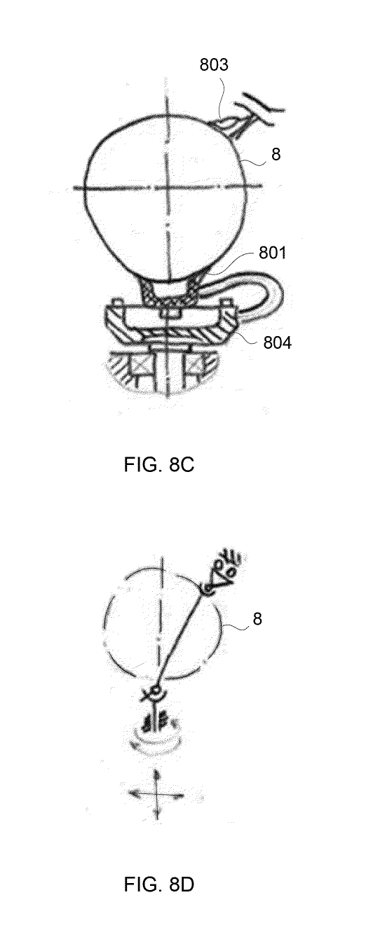

In the embodiment shown in FIG. 8A, a method for attaching directly underneath the fruit is shown utilizing a suction cup 801. In this embodiment, the vertical axis of the fruit 8 as defined by the fruit-branch attachment point 802 aligned with the suction cup 801, and the fruit 8 is removed by rotation only, as shown in FIG. 8B. However, because of the innovative design of the present invention, theoretical attachment is possible in a number of different geometries other than directly underneath the fruit. FIG. 8C shows a method for attaching to the fruit 8, when the vertical axis of the fruit does not coincide with the suction cup's axis of rotation. In this embodiment, tilting the suction cup 801 and controlling the force on a rotator 804 will help remove fruit 8 when the axis of rotation does not intersect the fruit-branch attachment point 803. In such cases, the exemplary suction cup 801 will still be capable of rotating the fruit 8 on a significant angle. In some embodiments, as soon as an excessive force is detected, the rotation of the fruit 8 can be reversed and/or another removal algorithm can be employed as shown in FIG. 8D. For example, the fruit 8 may be rotated at high speed using single or dual direction spin/torque methods to separate the stem from the fruit, leaving the button/star of the fruit intact. It is to be appreciated that different elements or combinations of elements may be utilized as the manipulators or grippers in the present invention to engage crops in different ways, including suction, movable and/or stationary tines, movable and/or stationary fingers, clamps, and combinations thereof. In some embodiments, crop severing elements may also be employed with or in place of the grippers to sever the crop from a branch, such as one or more cutting blades, scissors, shears, or saws (linear, motorized, rotary, etc.).

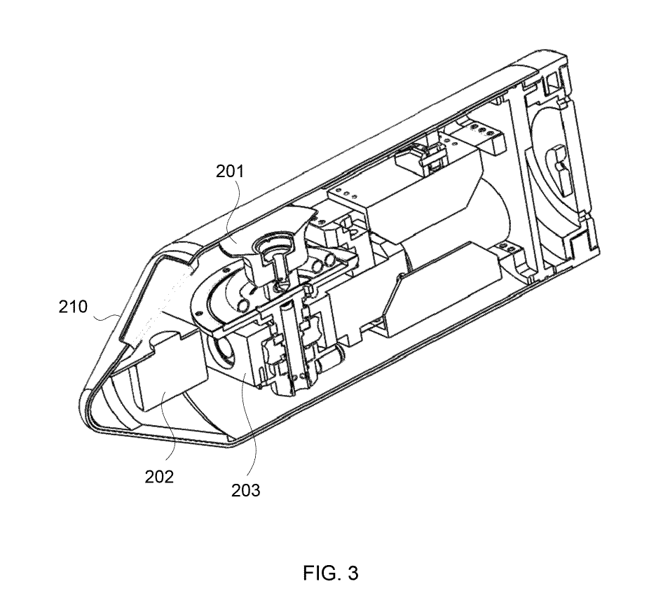

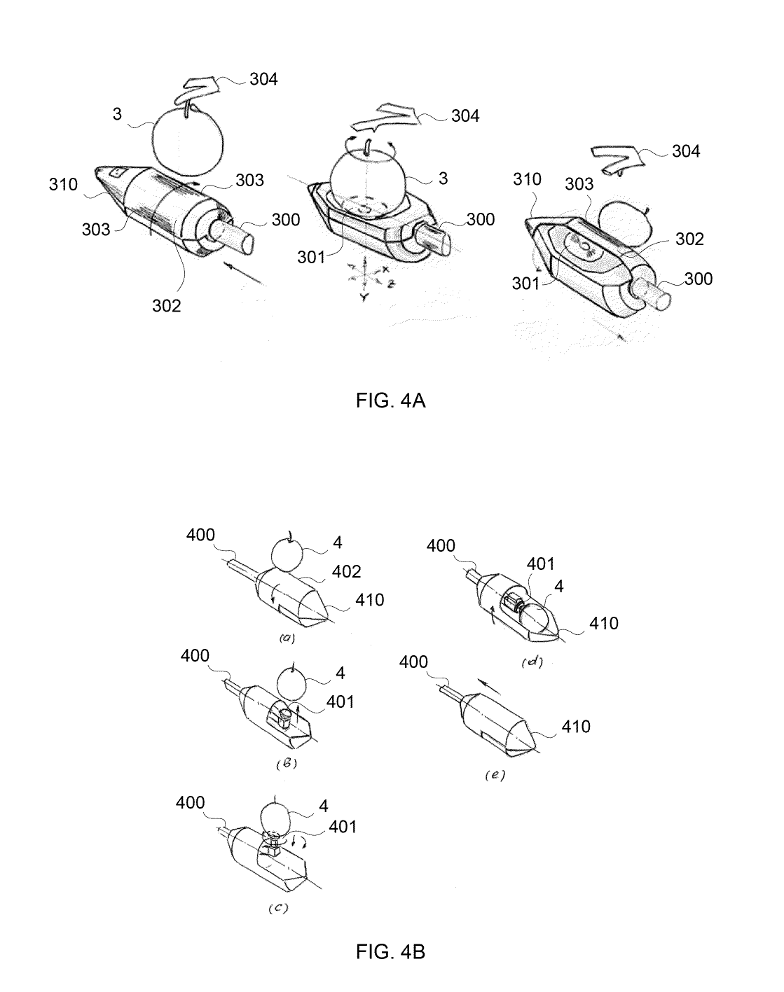

Referring to the exemplary embodiment shown in FIG. 3, a manipulator or end-effector 210 is shown comprising a suction cup 201, a sensor 202, and a camera 203. In some embodiments, the suction cup 201, the sensor 202, and the camera 203 are protected from dirt and debris by sliding or retracting covers (see e.g. 302 in FIG. 4A). The cover 302, optimally in combination with positive air pressure, protects the manipulator or end-effector 210 from dirt and debris, thus assisting in maintaining efficient picking.

FIG. 4A, shows the capture and rotary movements of an exemplary embodiment of a manipulator or end-effector 310 attached to a moveable arm 300. As shown in FIG. 4A, the gripper or suction cup 301 is covered by a movable cover 302, which is positioned below a fruit 3 by movement of the moveable arm 300 in the X, Y, and/or Z directions. After positioning the gripper or suction cup 301, the movable cover 302 is opened. In these embodiments, the moveable cover 302 may include special flange(s), rib(s) or brush(es) 303, which help to move branches or other materials out of the way so that the fruit 3 may be easily accessed. The moveable arm 300 and/or the gripper or suction cup 301 is moved upward to engage the fruit 3 through suction or other gripping means. The engaged fruit 3 may then be spun at high speed (or otherwise severed from the branch 304) to dislodge it from the branch 304.

Once the fruit 3 has been separated from the tree branch 304, it may be recovered by one of several possible methods. In some embodiments, the fruit 3 may be simply released from the picking module by reducing the vacuum pressure in the well of the gripper/suction cup 301, in which case it will fall by gravity to a collecting net or other material that is spread out beneath the tree canopy. In some embodiments, the fruit 3 may be withdrawn outside of the canopy, still attached to the picking module, and then released into a collection device located near the picking array (e.g. 30 in FIG. 1A). In some embodiments, the fruit 3 may be conveyed in a cyclical manner to a series of picking arms (not shown) in order to deliver it to a central location for collection or sorting. In some embodiments, a series of flexible or rigid rods (not shown) may be deployed into the fruit canopy to cushion the fall of the fruit, depending on tree geometry (height, density of canopy and branches). In these embodiments, the rods may be similarly deployed from the picking modules (e.g. 21 in FIG. 1A), although the rods generally have a much smaller diameter and preferably comprise a material softer than the telescopic arm 300 to cushion the fall of the fruit 3.

In some embodiments, the moveable arm 300 may be fully or partially retracted from the plant canopy (not shown) to simultaneously tear the fruit 3 from the branch 304 (or break the stem or branch 304) and position the fruit 3 over a collecting and transporting station (not shown). The suction cup 301 or grip is then released from the fruit 3, and the moveable arm 300 may be rotated or the movable cover 302 closed to allow the fruit 3 to drop to the collecting and transporting station below. The fall of the fruit 3 is slowed by the branches of the plant canopy and, in some embodiments, special soft beams, rods, lines or netting (not shown) inserted between branches also slow the fall of the fruit 3. The removable arm 300 is then positioned to pick another fruit, and the process repeated.

FIG. 4B shows a sequence of operation for another exemplary embodiment of a manipulator or end-effector 410. As shown in FIG. 4B, the manipulator or end-effector 410 is positioned below the fruit 4 by movement of the moveable arm 400. After the fruit 4 is in position over the end-effector 400, the moveable cover 402 is opened and the moveable arm 400, and end-effector 410 and/or suction cup/gripper 401 is moved upward to engage the fruit 4 through suction or other gripping action. The engaged fruit 4 may then be rotated at a high speed, pulled away from the branches or otherwise dislodged from the branch. At or about the same time, the suction cup 401 is moved downward, carrying the fruit 4 into the manipulator or end-effector 410. A combination of rotary motion and downward motion of the suction cup 401/end effector 410 effectively detaches the fruit 4 from the branch. The moveable cover 402 is then closed over the fruit 4, and the movable arm 400 retracts from the plant canopy (not shown). Enclosing the fruit 4 inside the end effector 410 protects the fruit 4 from damage as the moveable arm 400 is retracted from the plant canopy. The fruit 4 is then transferred to a collecting and transporting station (not shown).

By way of example only, and without limitation, a typical citrus tree configuration may be 12-14 feet in width and 16 feet high. If the exemplary system of FIG. 1A is used to search the plant canopy 1, the plant canopy 1 may be harvested in less than fifteen minutes (in some cases less than six minutes) with more than 90% (e.g., as much as 99%) of the fruit being picked. Depending on the number and configuration of the moveable arms, the harvesting of plant canopy 1 may take more or less time. Different variations in efficiency will be achieved for different combinations of the number of arms and manipulators. A large array of multiple independent harvesting arms will offer three to six times the number of picking arms of existing commercial products, permitting higher rates of fruit harvest.

In preferred embodiments of the invention, stereoscopic or alternative distance detecting sensors are used to enable higher picking speeds or rates. In some embodiments, these may be one or more cameras (e.g. web cameras) with feedback from a servo processor that is used to calculate distances to detected fruit so that efficient picking may be accomplished.

In preferred embodiments, the modular design of each arm (e.g., 22 in FIG. 1A) will allow for easy field replacement should an arm 22 become dysfunctional. Embodiments of the moveable arm and manipulators or grippers in the present invention are specially designed for outdoor use. In particular, properly protected manipulators are generally more reliable than standard industrial robotic components. The present machines are designed to be easily transportable and to operate in a robust combination of climatic conditions (rain, cold, dust, mud, etc.).

In embodiments of the invention, the search algorithm for an individual piece of fruit may be simplified compared with existing machine-vision systems that attempt detection and mapping. Referring to FIG. 6, by definition, each piece of fruit 5 on a tree already has a pre-existing Cartesian coordinate value, given its position in 3-D space as defined by the canopy 7. All fruit must be within the overall Cartesian values of a tree canopy; therefore if the gantry (e.g., 10 in FIG. 1A) is already surrounding the canopy of the tree, one automatically knows the “locations” of all pieces of fruit in the tree. The approach that is taken is to visit each value in Cartesian space and pick any/all of the fruit that appears at that value then move to the next sequential value in Cartesian space and repeat the operation. The search parameters may be adjusted to optimize both the time and number of approaches that are possible. By rotating the picking plane around the vertical (Y) axis of the tree (defined generally by the trunk or center of the apparatus), there may be numerous passes at certain locations within the tree canopy, depending on how much the array/module support member (e.g., 20 in FIG. 1A) is moved between passes, enhancing the opportunity to touch and remove each piece of fruit 5 should it be blocked along another pathway. See FIG. 5 showing a top view of overlapping process boxes 501 for a moveable arm 500 within a plant canopy 6, and FIG. 6 showing a perspective view of a three-dimensional process box 601 for a movable arm 600 within a plant canopy 7. It to be appreciated that very little overlapping will occur if the array/module support member 20 is rotated a long distance (e.g., 45°) between passes, but much more overlap will occur if the array is only rotated a few degrees (e.g., 5-15°) between passes. It is also to be appreciated that more overlapping will occur closer to the trunk or center of the canopy.

To further elaborate on the picking modules (e.g., 21 in FIG. 1A) or arm (e.g. 62 in FIG. 1B), in some embodiments, each module or arm can be equipped with one or more video cameras which can be used to guide the arms in real time, as opposed to first mapping the trees, then picking later. The picking arms 62 can scan through a relatively small envelope (e.g., the 200 mm×200 mm×1500 mm box referred to earlier, or some other appropriately sized space or area). In this way, a relatively simple manipulator (e.g. 110 in FIG. 2A) with two or three decoupled degrees of freedom is much easier to control and significantly faster than other systems with five or six axes of movement.

A novel aspect of the invention relates to the solution of a very common paradox that is currently confronting similar efforts. On the one hand is the common assumption that any mechanical harvester system must detect and harvest fruit or other crops at almost the same accuracy achieved by humans, and the system must be faster than humans. However, recent work on other robotic harvesters has demonstrated that the in-line computation time required in existing devices for detecting targets actually exceeds the actual motion time of the robot, with a significant reduction in efficiency. In contrast, the present invention actually initiates action towards a target even before knowing if a target exists, thus speeding the overall search/pick process.

It is likely that the systems developed in the future will still require significant processing and analysis time, thus making them much slower than traditional picking methods. This difficulty underlies all of the development efforts that rely on pre-identification and pre-spatial orientation of an orange or other fruit prior to picking. Embodiments of the present invention fundamentally define the spatial coordinates of a target and then instruct an arm to scan/detect and pick fruit if in that space. Because of variable fruit sizes, there are only certain or finite possibilities for a location of a piece of fruit in the three-dimensional space. In embodiments of the present invention, these possibilities for a location of fruit are pre-identified in search algorithms and assigned to various picking arms which then have only a relatively small space or area to search. When the moveable arms (e.g., 22 in FIG. 1A) have finished searching and removing fruit, the arms are then rotated to a different part of the canopy and the search algorithm is repeated.

Embodiments of the search algorithms may be adjusted to start at the bottom of the tree and work upwards or vice versa. As fruit is harvested, the branches will move upwards as the weight of the fruit is removed. Embodiments of the invention are self-adjusting in the sense that they can compensate for the removal of fruit and resultant upward movement of the branches. In particular, embodiments of the present invention have several vertically stacked rows of manipulators. If a branch bearing fruit moves up significantly, it automatically moves (upward) into the working zone of another manipulator. Alternatively, the search algorithms may be initiated in any direction including horizontal, diagonal or any other suitable pattern prescribed by the particular crop geometry.

Some embodiments of the present invention incorporate a field sorting module having one or more sensors capable of discriminating individual pieces of fruit according to physical, optical or other pre-defined characteristics. Such embodiments may group fruit into separate container systems. In present practice, most tree/plant crops are completely harvested with subsequent sorting of fruit at a packing house. In the case of citrus fruits, individual fruits that are not within predetermined size limits, that are cosmetically flawed or that have some other undesirable visual defect may be culled for use in juice products, for example. However, currently growers generally absorb the cost of hauling fruit to the packing house, sorting the fruit and additional shipping and/or handling to haul the product from the packing house to the juice factory. Using an embodiment of the present invention, one may field-sort a significant portion of citrus or other crops and send sorted fruit directly to a juice or other processing facility, saving on hauling costs. Embodiments of the present invention may include a design solution to field sort the citrus or other harvested products and separate them into different bins or collection systems to permit direct transfer of fruit to a processing plant rather than a packing house.

Embodiments of a field sorting module are programmable, using a variety of programming algorithms such as strategy patterns (policy patterns) that allow rapid reassignment based on the needs of the packing house or grower. This apparatus meets the various demands for the often rapid changes made on the part of growers who may be asked to pick by particular sizes on one day, and then possibly modify the picking and/or sorting criteria on another day in order to accommodate differing standards of market acceptance.

Other embodiments of the present harvesters provide for adaptation of the penetrator geometry for local application of sprays/fertilizers. At the present time, the predominant technology for application of nutrients and pest control agents is via large spray rigs that are driven through orchards and emit large clouds of material. This operation is highly inefficient. For example, only a fraction of the material remains on the trees; large clouds of material become airborne and are carried away from the orchard or deposited on the ground. Because of this inefficiency, the cost of application is unnecessarily high; the overall cost could be reduced significantly by the direct application of materials inside the canopy versus outside the canopy. A gradient of distribution exists from ground-based sprayers; lower layers of trees and plants have a higher distribution and deposition of materials than upper layers of the trees.

Therefore, utilizing the present invention to spraying nutrients and/or pest control agents results in relatively uniform application of chemicals and nutrients, both inside the canopy and within vertical layers of the canopy. In embodiments of the present invention, a relatively selective and effective distribution of chemicals/nutrients can be achieved by applying the chemical(s)/nutrient(s) directly onto and/or within the tree canopy with a plurality of spray nozzles that (i) reduce or eliminate airborne distribution outside the canopy, (ii) reduce the amount of materials applied, and (iii) reduce or eliminate the distribution gradient of chemicals/nutrients within the canopy resulting from use of external sprayers. Exemplary spray nozzles can be located on some or all of the mechanical arms, and can be deployed either in serial or parallel fashion throughout the tree canopy to ensure effective distribution.

In other embodiments of the invention, the modules (e.g., 21 in FIG. 1A) or moveable arms (e.g. 62 in FIG. 1B) may be fitted with mechanical blades, scissors or other cutting devices to be used to prune or thin the tree from the inside. At the present time, pruning is done by humans using hand-held clippers, and the operation is not as time efficient as possible in that it is effectively limited by mobility, environmental conditions such as heat or cold, a variable labor pool, etc. Each moveable arm 62 may be equipped with one or more sensors that enable detection of branches to be pruned and/or software (optimally using optical or other sensors) that may be utilized to guide and/or place the clipping/pruning mechanism onto the detected branches to be pruned. These embodiments are relatively efficient in that a number of simultaneous operations/mechanisms can be conducted, resulting in relatively rapid pruning/thinning of the tree.

The various harvesting machines, apparatus, systems and methods described herein provide numerous advantages over previously described systems including, but not limited to: (1) pre-mapping of fruit locations can be eliminated, which significantly reduces the complexity and increases the speed of picking operations by eliminating the need for complex software algorithms, stereoscopic machine-vision systems, and high density data storage systems; (2) a relatively simple manipulator with two or three decoupled degrees of freedom can be utilized, which simplifies the control and increases the speed of the apparatuses relative to systems with five or six axes of movement; (3) linear penetration of the moveable arms eliminates the need for a relatively complicated backtrack mechanism and is highly efficient due to the movable arms' linear speed, which may be approximately 1.5 meters per second or faster; (4) in embodiments utilizing a linear arrangement of picking arms, interference or conflict between arms can be avoided; (5) in embodiments having a linear arrangement of picking arms, a very efficient picking pattern can be established, working from outside to inside, eliminating any need for complicated computing algorithms; (6) in embodiments having a pre-determined search grid for each module/arm, efficiency of picking can approach 100%, since the harvester is able to cover every or nearly every possible location for a piece of fruit; (7) the use of multiple work zones for the moveable arms that overlap toward the center of the tree increases the probability of reaching fruit that is obscured or located relatively deep in the tree canopy; (8) the rotation of the modules or arrays of picking arms around the tree mitigates the presence of thick branches, accomplishing multiple solutions to picking a given piece of fruit without computer computations or analysis; (9) there is no requirement for pre-planning or computation of an ideal picking solution; (10) placement of cameras or other sensors on each penetrator arm automatically ensures visualization/detection of all fruit in a tree or plant canopy; (11) since all geographic solutions can be covered, all fruit can be detected; and (12) embodiments provide a single integrated device design, minimizing or eliminating the need to control more than one vehicle/apparatus and resulting in a less expensive system than systems that require separate scouting and picking vehicles or apparatuses.

It is to be appreciated that the term “crops” referred to herein and in the appended claims is to be interpreted broadly to include any harvestable portion of a plant that may be used for commercial purposes, and includes without limitation, fruit, nuts, vegetables, leaves, heads, any part of a flower, shoots, seeds, pods, bulbs, etc., or any part or portion thereof.

### CONCLUSION/SUMMARY

Thus the present invention provides apparatuses for robotic scanning, spraying, pruning and/or picking of agricultural crops and related methods that do not require pre-mapping or pre-knowledge of the position or location of crops on plants and do not require pre-calculation of a spraying, pruning or picking plan. The apparatuses and methods employ highly-packed modules or arrays of movable arms that are rotated around a plant canopy to quickly and efficiently scan, spray, prune or pick the agricultural crops or other items of interest.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

1. An apparatus comprising:
a support structure configured to be placed in proximity to a crop-bearing plant canopy, the support structure comprising:
a frame;
a central vertical shaft or axis attached to the frame, configured to be substantially aligned with a center of the plant canopy; and
at least one module support member comprising a horizontally-extending portion and at least one vertical member attached to the horizontally-extending portion, wherein each module support member or the frame is capable of rotating around the plant canopy;
a plurality of moveable arms attached to each of the at least one vertical member of the support structure, each moveable arm facing generally inward toward the plant canopy and being independently capable of extending into the plant canopy and retracting from the plant canopy;
at least one detector attached to each moveable arm; and
at least one electronic controller configured to operate the support structure, the at least one module support member, the moveable arms, and the detectors.

2. The apparatus of claim 1, wherein each moveable arm has at least two degrees of freedom in the horizontal and vertical planes relative to a ground surface.

3. The apparatus of claim 1 wherein the moveable arms comprise separately controlled telescopic arms.

4. The apparatus of claim 2, wherein the electronic controller is further configured to operate each of the moveable arms and the detectors to independently search within a defined three-dimensional space inside the plant canopy, and transmit and/or store resultant search data.

5. The apparatus of claim 3, wherein each of the detectors is selected from the group consisting of a scanner, a camera, a chemical sensor, an optical sensor, an optomechanical sensor, an infrared sensor, a thermal sensor, a pressure sensor, a flow sensor, a touch sensor, a proximity sensor, a color sensor, and combinations thereof.

6. The apparatus of claim 3, further comprising:
at least one applicator attached to each moveable arm; and
at least one reservoir of material to be applied within the plant canopy using the applicator, wherein the at least one controller is further configured to communicate with the sensors, the applicators, and the reservoirs to deliver a controlled amount of the material to an identified location within the plant canopy.

7. The apparatus of claim 3, further comprising:
at least one manipulator attached to each moveable arm, wherein the at least one controller is further configured to operate each manipulator.

8. The apparatus of claim 7, wherein the manipulator comprises at least one crop removal device, wherein the at least one controller is further configured to communicate with the sensors and the at least one crop removal device to remove a crop from within the plant canopy, and the apparatus further comprises at least one receptacle configured to receive the removed crop from the crop removal device.

9. The apparatus of claim 8, wherein the crop removal device is selected from the group consisting of a suction cup, a pneumatic gripper, a moveable clamp, moveable fingers, moveable tines, and combinations thereof.

10. The apparatus of claim 7, wherein the manipulator comprises:
at least one pruning device configured to trim or prune inside the plant canopy, wherein the at least one controller is configured to operate each pruning device.

11. The apparatus of claim 3, further comprising a motor vehicle capable of movement along and between rows of plant canopies, wherein the support structure is mounted to the motor vehicle.

12. The apparatus of claim 3, wherein the frame comprises a gantry configured to spanning the plant canopy.

13. The apparatus of claim 12, further comprising a mechanism coupled to the gantry configured to level the gantry.

14. The apparatus of claim 12, further comprising at least one camera attached to the gantry, and (i) an operator station configured to manually control movement of the gantry, or (ii) a communication system configured to communicate with the at least one camera and a remote control station to remotely control movement of the gantry, from the plant canopy to a next plant canopy.

15. A method of penetrating a plant canopy, the method comprising:
causing a plurality of moveable arms attached to vertical members of a support structure to be extended into a defined three-dimensional space corresponding to the plant canopy where crops or other items of interest may be found;
searching for the crops or other items of interest in the three-dimensional space;
transmitting and/or storing data from said searching;
retracting the moveable arms from the plant canopy;
repositioning the module support member or the frame; and
repeating the steps of causing the plurality of moveable arms to extend into the plant canopy, searching for crops or other items of interest, transmitting and/or storing data from the searching, retracting the moveable arms from the plant canopy, and repositioning the module support member or frame.

16. The method of claim 15, further comprising:
sensing at least one characteristic of each detected crop or other item of interest; and
transmitting and/or storing data relating to the characteristic.

17. The method of claim 15, further comprising (i) detaching detected crops or removing the items of interest from the plant canopy, and transporting the detached crops or removed items of interest to a receptacle, (ii) applying a controlled amount of material from a reservoir to an identified location within the plant canopy, or (iii) pruning inside the plant canopy.

18. The method of claim 15, further comprising moving the support structure between rows of plant canopies or from the plant canopy to a next plant canopy.

19. A method of manufacturing an apparatus for penetrating a plant canopy, the method comprising:
assembling a support structure by:
attaching a plurality of support members to each other to form a frame;
attaching a central vertical shaft or axis to a central position of the frame;
assembling a module support member by attaching at least one vertical member to a generally horizontal member;
attaching the module support member to the central axis so as to allow the module support member or the frame to rotate around the plant canopy;
attaching a plurality of moveable arms to each of the at least one vertical member, each moveable arm configured to face inward toward the plant canopy, and each arm capable of extending into the plant canopy and retracting from the plant canopy;
attaching at least one detector to each moveable arm; and
communicatively connecting at least one electronic controller to the support structure, the module support member, the moveable arms, and the detectors.

20. The method of claim 19, further comprising attaching an applicator to each moveable arm, and communicatively connecting the at least one controller to the applicator and to a reservoir of material to be applied within the plant canopy with the applicator.

21. The method of claim 19, further comprising attaching a manipulator to each moveable arm, and communicatively connecting the at least one controller to the manipulator.

22. The method of claim 19, further comprising attaching at least one camera to the support structure and (i) attaching an operator station to the support structure, or (ii) communicatively connecting the at least one camera and a remote control station to the support structure, to enable control of movement of the support structure.
